(19) United States
(12) Patent Application Publication
(10) Pub. No.: US 2014/0130904 A1
(43) Pub. Date: May 15, 2014

(54) ACTUATOR WITH VISUAL INDICATOR SLEEVE

(71) Applicant: SWAGELOK COMPANY, Solon, OH (US)

(72) Inventors: William H. Glime, III, Chagrin Falls, OH (US); Branden W. Keeper, Mentor, OH (US); Thomas DiBiase, Mountain House, CA (US)

(73) Assignee: SWAGELOK COMPANY, Solon, OH (US)

(21) Appl. No.: 13/785,606

(22) Filed: Mar. 5, 2013

Related U.S. Application Data
(60) Provisional application No. 61/724,413, filed on Nov. 9, 2012.

(51) Int. Cl. F16K 37/00

(52) U.S. Cl. CPC F16K 37/00
USPC 137/377

(57) ABSTRACT

A device, for example a flow control device, and actuator or both are provided with a heat shrinkable sleeve about an exterior surface of a housing for the device. The heat shrinkable sleeve may contain indicia or information relating to the device. The heat shrinkable sleeve may also be used to contain fluid and contaminants that escape from the device from exposure to an environment that is exterior the heat shrinkable sleeve. The housing may include structure that retains the heat shrinkable sleeve in an installed position. Such structure may be, for example, a recessed surface, a flange, a crimp or other structure.

### RELATED APPLICATION

The present application claims the benefit of U.S. provisional patent application No. 61/724,413 for ACTUATOR WITH VISUAL INDICATOR SLEEVE, filed on Nov. 9, 2012, the entire disclosure of which is fully incorporated herein by reference.

### TECHNICAL FIELD OF THE DISCLOSURE

The inventions relate to actuators for flow control valves and other devices. The inventions more particularly relate to actuators that have visual indicia related to information about the actuator or valve or both.

### BACKGROUND OF THE DISCLOSURE

Actuators may be used for many different functions and operations. One example is to open and close a valve. Actuators may be pneumatic, for example, thus allowing automatic or electronic control of the valve, as distinguished from manual operation using a manual valve actuator with a handle. The teachings herein may be conveniently used for many different valve configurations, including normally open and normally closed valves.

### BRIEF DESCRIPTION OF THE DRAWINGS

FIG. 1 is a prior art actuator and valve assembly illustrated in a closed position, and configured as a normally closed valve, shown in isometric view,

FIG. 2A is an embodiment of a contoured actuator housing,

FIG. 2B illustrates the actuator housing of FIG. 2A with a shrink sleeve installed thereon,

FIG. 3 are exemplary embodiments of shrink sleeves in accordance with the teachings herein,

FIG. 4 is an embodiment of a pneumatic actuator and valve assembly with a shrink sleeve installed thereon, in isometric,

FIG. 4A is the embodiment of FIG. 4 in longitudinal cross-section,

FIG. 5 is an enlarged view of a modified weep hole for the hybrid actuator of FIG. 4,

FIG. 6 is an embodiment of a modified cap for use with a shrink sleeve in accordance with the teachings herein, and

FIG. 7 illustrates an embodiment of a modified crimp flange in accordance with the teachings herein,

FIG. 8 is an embodiment of a hybrid actuator and valve assembly with a shrink sleeve installed thereon, in isometric.

### DETAILED DESCRIPTION OF EXEMPLARY EMBODIMENTS

The teachings herein may also find application and use for controlling a valve of configurations and types other than the exemplary valve designs shown herein. The teachings herein may also find application and use with flow control devices other than valves. We show in the exemplary embodiments herein an actuator that is a manual valve actuator, an embodiment with an automatic valve actuator, for example a pneumatically operated actuator, and an embodiment with a hybrid actuator. By hybrid actuator we mean an actuator that may be automatically operated, for example, with a pneumatic actuator, and may also include a manually actuated operation, for example a manual actuator that can among other things be used as a manual override. Therefore, the inventions herein may be used many devices, including but not limited to: a flow control device, for example a valve; an actuator, as an example an actuator for a flow control device, for further example a manual actuator, an automatic actuator or a hybrid actuator; or a device that includes a combination of a flow control device and actuator therefor.

A first inventive concept presented herein considers using a sleeve to provide information and other indicia for a flow control device such as a valve, an actuator for a flow control device, or both. In one embodiment of this first concept, a shrink sleeve is installed on a flow control device or actuator or both wherein the shrink sleeve includes one or more indicia or other information relating to the flow control device or actuator. An example of a shrink sleeve is a heat shrink sleeve. Additional exemplary embodiments of this first concept are described below.

A second inventive concept presented herein considers the use of a sleeve with a flow control device or actuator or both. In an exemplary embodiment, a structure is provided for the flow control device, the actuator or both that retains the sleeve in an installed position. For example, in another embodiment the structure can be used to resist axial displacement of the sleeve during normal handling and use of the flow control device or actuator. Additional exemplary embodiments of this second concept are described below.

A third inventive concept presented herein considers the use of a sleeve that is installed on a flow control device, an actuator or both wherein the sleeve is installed on an exterior portion or surface and assists in containing fluid and contaminants from exposure to the external environment. In one embodiment of this concept, an actuator, flow control device or both may include features that vent pressure or allow for the release of fluid or other contaminants, with the sleeve functioning to contain the fluid or other contaminants from exposure to an environment that is exterior the sleeve. Additional exemplary embodiments of this third concept are described below.

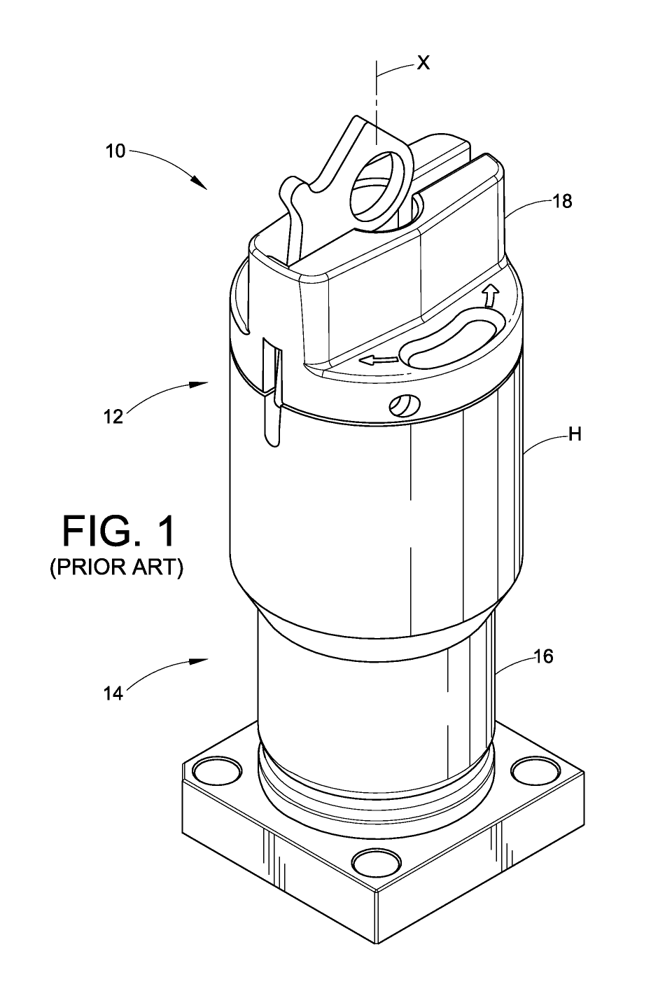

With reference to FIG. 1, an actuator and valve assembly 10 may include a manual actuator assembly 12 and a valve assembly 14. This assembly 10 may be, for example, a DE series manual actuator and valve assembly manufactured and sold by Swagelok Company, Solon, Ohio. The valve assembly 14 may have many different configurations and uses. In the exemplary embodiment herein, the valve assembly 14 may be realized in the form of a diaphragm valve having a valve body 16 that has two or more flow passages therein so as to control the flow of fluid, for example a liquid or gas, from one port to another.

In a typical diaphragm valve, an inlet port opens to an inlet flow passage that opens to a valve cavity. An outlet port opens to an outlet passage which also communicates with the valve cavity. The valve cavity opens to the outlet flow passage through an annular valve seat. A diaphragm seals the valve cavity when it is in contact with the valve seat. The diaphragm is moved toward and into contact with the valve seat to close the valve and is moved away from and out of contact with the valve seat to open the valve. The diaphragm movement is effected by operation of the actuator. Operation of a diaphragm valve as described is well known and need not be further described herein to understand and practice the teachings herein, but it should be noted that many other types of valves may be used other than a diaphragm valve, for example, a bellows valve or shutoff valve to name just two examples. The valve assembly 14 may alternatively include additional ports and flow passages, for example, a three way valve, and flow may alternatively be bi-directional.

In the case of a manually operated actuator 12, a handle 18 may be provided that is turned about the central longitudinal axis X of the assembly 10. For example, the valve assembly 14 may be a quarter turn valve, meaning that the handle 18 is rotated clockwise ninety degrees about the axis X from the open position in order to close the valve. The actuator assembly 12 includes an actuator housing or enclosure H. The housing H may be made of a suitable material, for example, aluminum.

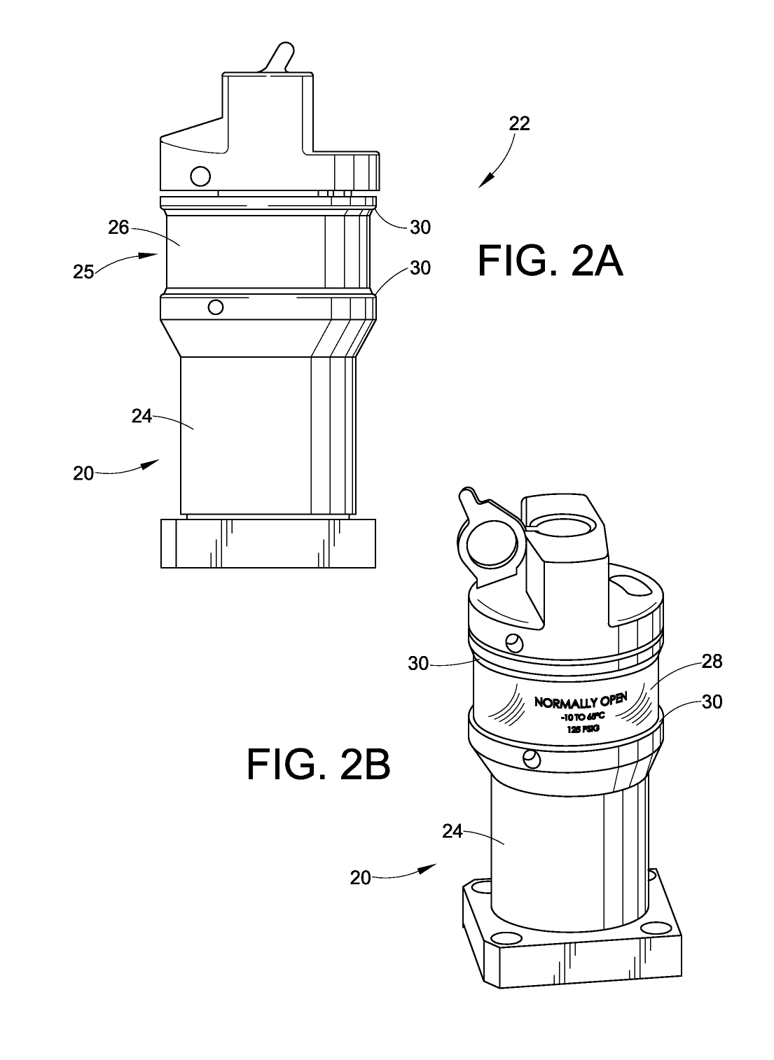

With reference to FIGS. 2A and 2B we illustrate another embodiment of the first two concepts discussed above. An actuator and valve assembly 20 has an actuator assembly 22 that includes an actuator housing or enclosure 24. The actuator housing 24 may be made of a suitable material, for example, aluminum. In contrast to the housing H illustrated in FIG. 1, the actuator housing 24 is provided with a structure 25, for example an exterior contour or profile, that facilitates aligning and retaining an informational device in an installed position on the assembly 20.

In another exemplary embodiment, for example, the housing 24 may include a recessed surface 26, which, for example, may be a cylindrical surface. As illustrated in FIG. 2B, an informational device in the form of a sleeve 28 is disposed onto the recessed surface 26 of the actuator housing 24. This sleeve 28 may include any desired indicia or information in any form, for example, the manufacturer's name, product type, product related specifications (for example pressure and temperature ratings, valve style such as normally open or closed), color coding, bar coding and so on. Preferably, the sleeve 28 is a shrink sleeve or shrinkable sleeve. As noted below, a preferred but not required embodiment of a shrink sleeve is a sleeve that is made of a heat shrinkable material, for example, a polyolefin material such as polyethylene or polypropylene. Being made of a heat shrinkable material allows the sleeve 28 to be easily positioned on the recessed surface 26 and then heated to shrink it to a tightly or snugly conforming state on the housing 24. The application of heat causes the sleeve 28 to shrink and closely conform to the recessed surface 26. An adhesive for the sleeve 28 is not needed although may alternatively be used. Light shading in the drawings represents transparency or coloring for example.

In the embodiments herein that are described as using a shrink sleeve such as, for example, a heat shrink sleeve it should be noted that many different types of shrink sleeves may alternatively be used. A heat shrink sleeve is but one example of many. Other examples include but are not limited to shrink sleeves made of a material that shrink upon exposure to a chemical gas, radiation (for example, UV radiation),or other non-thermal methods or activators. Still further alternatives are a roll-on sleeve that can be initially glued to a body and then shrunk using heat or other methods or activators to induce shrinkage. A further alternative to a heat shrink sleeve is a sleeve that comprises an elastic material that can be stretched over or around a product and then released. The inherent elasticity of the stretch material would allow the elastic sleeve to conform to the product or device without application of heat or other activator.

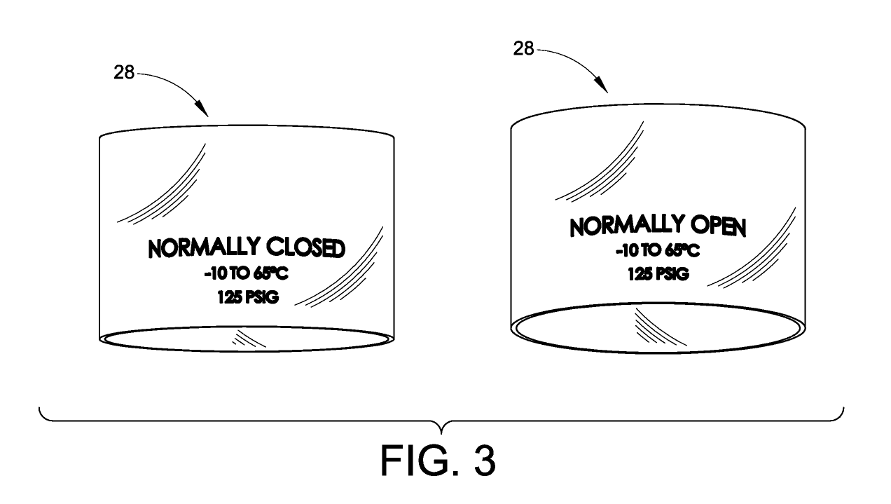

The structure 25, for example the recessed surface 26, facilitates use of the shrink sleeve 28 by presenting one or more capture or retention surfaces 30 that resist axial movement of the shrink sleeve 28 along the surfaces of the actuator and valve assembly 20. Even though the shrink sleeve 28 can be shrunk into tight engagement with a cylindrical or other shaped surface, the shrink sleeve 28 could still slide along such a surface during normal use and handling. The retention surfaces 30 resist such movement so that the shrink sleeve 28 remains in its installed position or place during normal operational use and handling of the assembly 20. Other retention surfaces or features for retaining the shrink sleeve 28 in position may alternatively be used, for example, a protrusion, raised ring or other raised surface or contour may be used to help retain the shrink sleeve 28 in position on the actuator housing 24. FIG. 3 illustrates some examples of the shrink sleeve 28 prior to being shrunk; but the actual informational content that is placed on the shrink sleeve 28 may be selected for specific purposes.

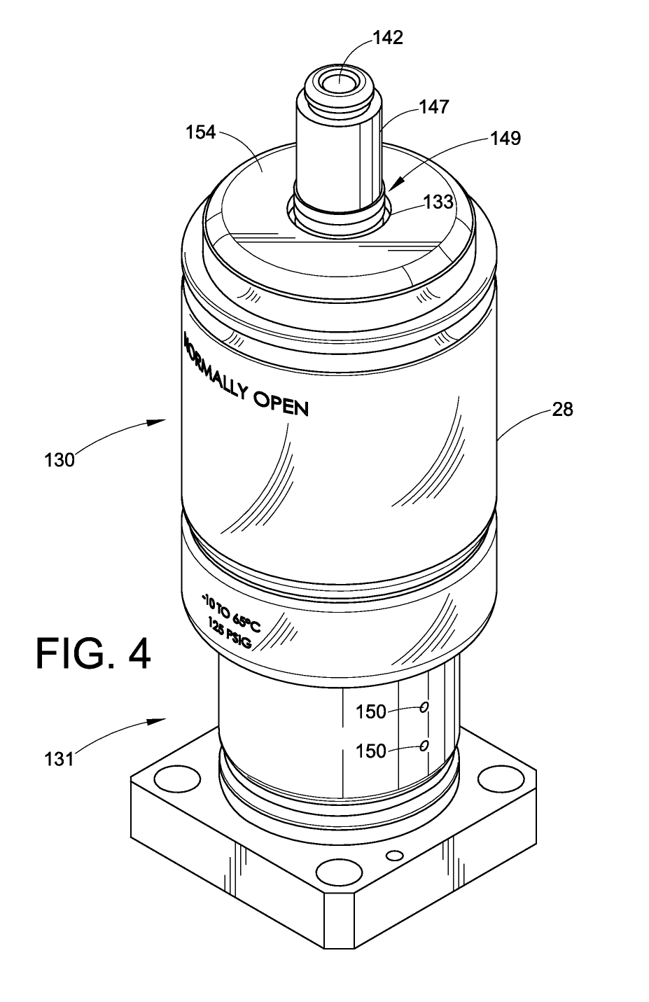

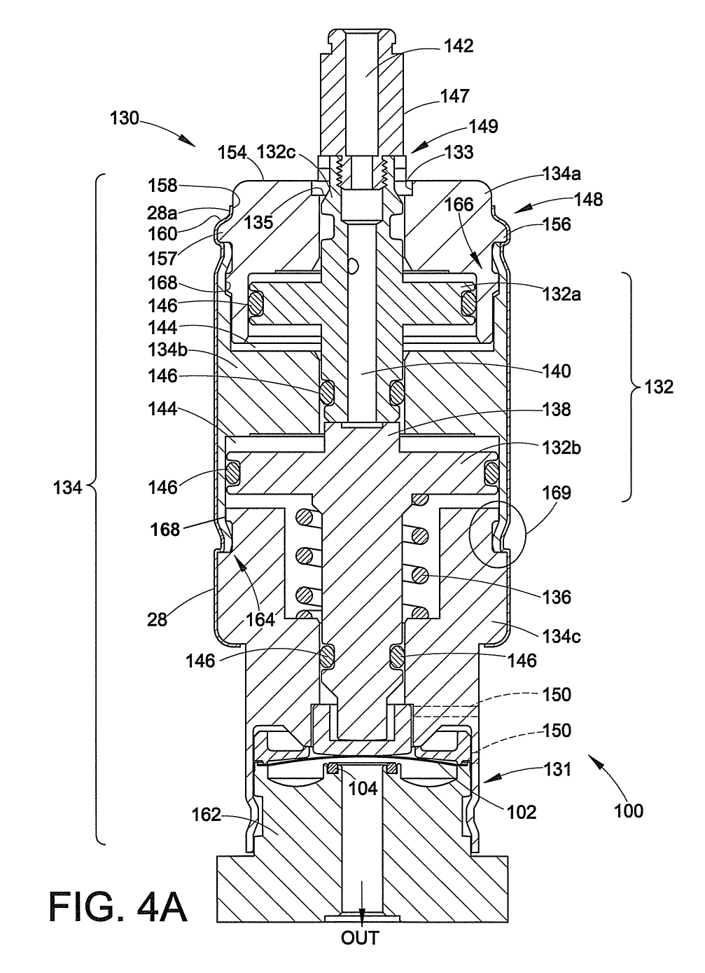

FIGS. 4 and 4A illustrate an embodiment of a pneumatic actuator and valve assembly 100 that includes a pneumatic actuator assembly 130 and a valve assembly 131. The pneumatic actuator assembly 130 commonly includes a piston assembly 132 that is disposed in a housing 134. In the exemplary embodiment, two pistons 132a and 132b may be used but alternatively a single piston actuator may be used or more than two pistons may be used as needed. A spring 136 is used to urge the piston assembly 132 in a first direction that pushes a diaphragm 102 into sealing engagement with a valve seat 104, thereby providing a normally closed valve (the closed position is not shown in the drawings). The piston assembly 132 may include an actuator stem 138 that has an air passage 140 therethrough. The air passage 140 is in fluid communication with an air inlet 142 that receives pressurized air from a pressurized air source (not shown). The air passage 140 communicates with a piston chamber 144 so that when pressurized air is supplied to the pneumatic actuator assembly 130, the air pressure overcomes the spring 136 bias and moves the piston assembly 132 against the force of the spring 136 to a second or open position (FIG. 4 illustrates the open position), which allows the diaphragm 102 to move to the open position away from the valve seat 104. When air pressure is removed, the spring 136 returns the piston assembly 132 to the first position and the valve is closed. O-rings 146 or other suitable seals provide pressure containment for the actuator pressurized air to move the piston assembly 132. The housing 134 may include a cap 148 that receives an air fitting 147 to provide the air inlet 142. Note that FIG. 4 illustrates a shrink sleeve 28 positioned on the assembly 100.

The upper piston 132a may include a piston extension 132c that protrudes through an opening 133 in the cap 148. The piston extension 132c may be threadably connected with the air fitting 147. One or more indicator rings 149 may be carried by the piston extension 132c. The indicator rings 149 are adapted to be received inside the cap opening 133 when the valve 131 is in a closed position (not shown). This causes the indicator rings 149 to be hidden from view when the valve is closed, and visible when the valve is in an open position such as in FIGS. 4 and 4A. The indicator rings 149 may be provided with an outside diameter that causes the indicator rings 149 to contact a recessed shoulder 135 when the piston assembly 132 is lowered to close the valve. This contact assures that the indicator rings 149 always return to a reference position on the piston extension 132c when the valve closes, so that when the valve is subsequently opened the indicator rings 149 will be in proper position for visibly indicating the open condition of the valve.

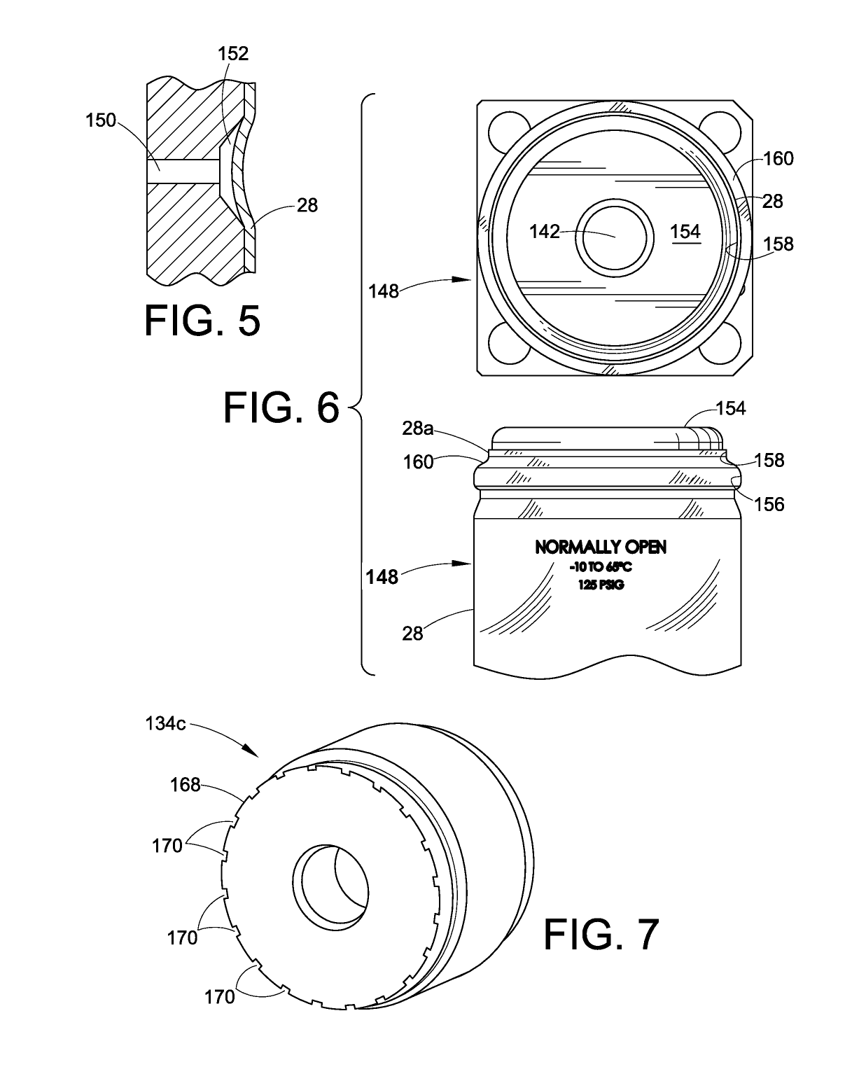

The valve assembly 131 may include one or more passages 150, for example weep holes 150, that provide a flow path to allow pressurized air or fluids such as lubricants or other contaminants to escape the assembly interior, as is known. These weep holes 150 are used, for example, to prevent process fluid from entering into the actuator assembly 130, or to allow lubricants and other debris or contamination to pass out of the actuator assembly or the valve assembly so as not to interfere with normal operation of the actuator or valve. In some embodiments, it may be desired to use a heat shrink type shrink sleeve 28 on the valve assembly 131 which could block the passages 150 and basically seal the passages 150 due to the tight contact of the shrink sleeve 28 against the housing 134 exterior surface. In order to maintain the function of the passages 150, we show in FIG. 5 a modified design. In this embodiment, each passage 150 may open to an annular groove 152 or other enlarged volume formed on the housing 134 and that is in fluid communication with the passage 150 so as to allow gas or other fluids and contaminants like extruded lubricants to vent into the groove 152 volume and the space or volume that is between the shrink sleeve 28 and the housing 134 exterior surface. In this manner, the shrink sleeve 28 may be used to improve environmental cleanliness by containing or trapping fluid and contaminants from exposure to the environment that is exterior of the shrink sleeve 28.

It should be noted that passages 150 may also be used as a vent hole with the actuator assembly 130, for example to vent fluid pressure from the actuator (not shown). In such cases, the shrink sleeve 28 may be used and the enlarged volume 152 concept may also be used so that the shrink sleeve 28 does not block the vent hole 150. In the exemplary embodiments herein we provide a different structure for venting the actuator as will be further described below.

Note from FIGS. 4, 4A and 6 that the shrink sleeve 28 does not extend over the top surface 154 of the cap 148. This is because a short end portion of the shrink sleeve 28 could present a raised edge that might not be aesthetically pleasing and could become worn. With particular reference to FIGS. 4A and 6 we provide a flange or protrusion 156 that extends in a radial direction from the cap 148 outer surface. This flange 156 allows an end portion 28a of the shrink sleeve 28 to shrink or wrap around an upper surface 157 of the flange 156 and also around a vertical cylindrical surface 158 of the cap 148 thereby avoiding a raised edge. This also provides a transverse portion 160 of the shrink sleeve 28 that is visible from above the assembly 100. In this manner, the shrink sleeve 28 may include indicia such as color or letter or other symbol that provides information to an observer, such as, for example, whether the valve is a normally open or normally closed valve, even when the assembly is viewed from the top.

The embodiment of FIGS. 4 and 4A illustrates a housing 134 that has multiple pieces. For example there may be a cap portion 134a (corresponding to the cap 148 noted above), an actuator portion 134b, a valve portion 134c also being connected or joined to a valve body 162. These various sections may be joined by crimping. For example, a crimp 164 may be used to join the valve body 162 with the actuator portion 134b; and a crimp 166 may be used to join the actuator portion 134b to the cap portion 134a. The crimps 164, 166 are done by deforming a portion of the outer member around a crimp flange 168.

As noted above, pneumatic actuators commonly include one or more flow paths, such as vent holes for example, to provide a passage that can vent pressure in the event of blow by of the seals 146. We have found that we can use the crimp structure 164, 166 as a flow path to vent the actuator assembly 130 rather than having to provide vent holes. Air can escape through the crimps 164, 166 because the crimps do not form air tight pressure seals thereby providing a passage for air to be vented from the actuator assembly 130.

As is illustrated in FIG. 4A, a heat shrink sleeve 28, when installed on the actuator assembly 130, covers the crimps 164, 166. This can create an air tight seal region 169 between the shrink sleeve 28 and the crimp flange 168 to reduce or block venting. This could reduce the effectiveness of using the crimps to vent air pressure from the actuator assembly 130. In an optional embodiment, we knurl, notch or otherwise add a surface feature, for example in the circumferential portion, to the crimp flange 168 that disrupts the seal region 169 at each crimp 164, 166, so that the shrink sleeve 28 can release or vent pressure. FIG. 7 illustrates an embodiment of adding a surface feature, for example notches 170, to the crimp flange 168 to allow pressure to be vented. This surface feature 170, for example the notches 170 or knurling, may be used for venting by allowing air to pass through the crimp 164, 166 more easily and into the volume or space between the shrink sleeve 28 and the exterior surfaces of the housing 134. Therefore, the surface feature 170 may be used in place of or in combination with vent holes (not shown for the actuator).

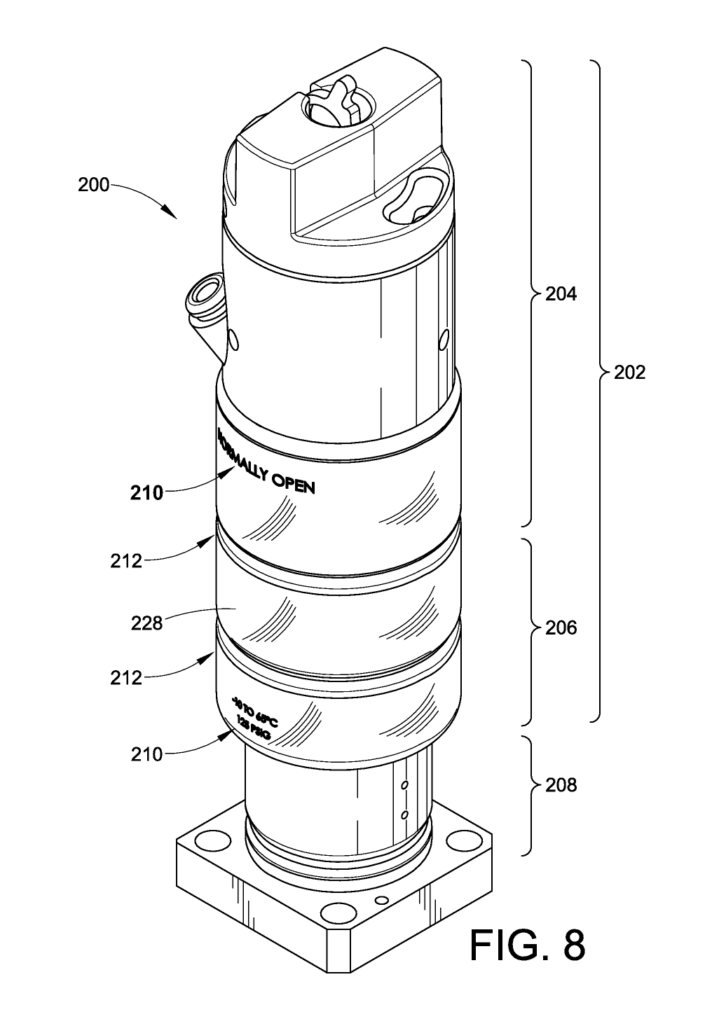

With reference to FIG. 8, we illustrate an embodiment of a hybrid actuator and valve assembly 200, which includes a hybrid actuator 202 having a manually operated actuator assembly 204 stacked on top of a pneumatic actuator assembly 206, both of which can be used to control a flow control device 208, for example, a diaphragm valve. Individually, the manual and pneumatic actuators 204, 206 may be designed and operated as described hereinabove or may have other designs and operation. Moreover, the hybrid actuator 202 may be operated such that the manual actuator 204 can be used to override operation of the pneumatic actuator 206. The hybrid actuator 202 may include a shrink sleeve 228 in a manner described hereinabove, for example a heat shrink sleeve, with indicia and information 210 thereon. The hybrid actuator 202 may include a multi-piece housing that is crimped so that the crimps 212 provide a structure by which the shrink sleeve 228 is retained in its installed position. For example, the contours present due to the crimping will oppose axial movement of the shrink sleeve 228 during normal use and handling.

The shrink sleeve 28 may also serve to help protect the exterior surface of the housing 24 (which may be, for example, bare aluminum) from scratches and abrasions or other wear that could generate particles, particularly for clean room applications. The shrink sleeve 28 may also be provided with clear or transparent portions that serve as viewing windows to view features, structure or other labels and visual indicia underneath the shrink sleeve 28. The shrink sleeve 28 may also be used to hold such additional structures in place. The shrink sleeve 28 may also be provided with coloring or ink in the heat shrinkable material that changes when the valve or actuator is exposed to temperatures exceeding product ratings. This color change may be permanent so that the manufacturer would know that the product was exposed beyond such temperature limits. Alternatively, the shrink sleeve 28 may be used to position and hold a temperature sensitive label, band, strip or other piece of material underneath the shrink sleeve 28 against the exterior surface of the housing 24, in which the temperature sensitive strip changes color based on the product being exposed to temperatures beyond the product rating. Color changing materials for the shrink sleeve 28 or retained by the shrink sleeve 28 may also be used for other environmental monitoring, such as, for example, whether a product has been exposed to moisture or other deleterious atmosphere or conditions.

While various aspects and features and concepts of the inventions are described and illustrated herein as embodied in various combinations in the exemplary embodiments, these various aspects, features and concepts may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices and so on may be described herein, such descriptions are not intended to be a complete or exhaustive list of available alternative embodiments, whether presently known or later developed. Those skilled in the art may readily adopt one or more of the aspects, concepts or features of the various inventions into additional embodiments within the scope of the present inventions, even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present inventions however, such values and ranges are not to be construed in a limiting sense and are intended to be critical values or ranges only if so expressly stated. Additionally, even though some features and aspects and combinations thereof may be described or illustrated herein as having a specific form, fit, function, arrangement or method, such description is not intended to suggest that such descriptions or illustrated arrangements are required or necessary unless so expressly stated. Those skilled in the art will readily appreciate additional and alternative form, function, arrangement or methods that are either known or later developed as substitute or alternatives for the embodiments and inventions described herein.

The inventions have been described with reference to the exemplary embodiments. Modifications and alterations will occur to others upon a reading and understanding of this specification and drawings. It is intended to include all such modifications and alterations insofar as they come within the scope of the appended claims or the equivalents thereof.

We claim:

1. An actuator comprising a housing, a shrink sleeve and a structure that retains said shrink sleeve in position on said housing.

2. The actuator of claim 1 wherein said sleeve comprises a heat shrinkable polyolefin material.

3. The actuator of claim 1 wherein said structure comprises a recessed surface.

4. The actuator of claim 3 wherein said recessed surface is cylindrical.

5. The actuator of claim 1 in combination with a valve assembly, said valve assembly comprising a valve housing, wherein said valve housing comprises a passage that opens to a valve cavity so that fluid or contaminants are vented between said shrink sleeve and an external surface of said housing and said fluid or contaminants are contained from exposure to the environment that is exterior said shrink sleeve.

6. The actuator of claim 5 wherein said passage opens to a groove that allows fluid and contaminants to pass from said valve cavity through said passage and into a volume between said shrink sleeve and an outer surface of said housing.

7. The actuator of claim 1 wherein said housing comprises at least a first portion and a second portion that are joined together by a crimp, one of said first portion and said second portion comprising a crimp flange, said crimp flange comprising a surface that allows pressure to vent past said crimp into a volume between said shrink sleeve and an exterior surface of said housing.

8. The actuator of claim 7 wherein said surface comprises knurling to allow fluid pressure to vent past said crimp.

9. The actuator of claim 1 wherein said shrink sleeve comprises a material that changes color or secures a device that changes color when the actuator has been exposed to an environmental condition beyond a desired limit.

9. The actuator of claim 1 wherein said structure resists axial movement of said shrink sleeve from an installed position.

10. The actuator of claim 9 wherein said structure comprises a flange or a recessed surface or a raised surface.

11. A device comprising:
a housing, said housing comprising at least one flow path through said housing to vent pressure or to allow release of fluid and other contaminants,
a shrink sleeve disposed about an exterior surface of said housing, said shrink sleeve having close contact with said exterior surface so that said fluid and other contaminants are contained from exposure to an environment that is exterior said shrink sleeve.

12. The device of claim 11 comprising a flow control device, an actuator for a flow control device or both.

13. The device of claim 12 wherein said housing comprises a wall and said at least one flow path comprises a passage that extends from an internal volume of said housing through said wall, said shrink sleeve being disposed about said wall to contain fluid or contaminants from exposure to an environment that is exterior said shrink sleeve.

14. The device of claim 13 wherein said passage opens to a valve cavity.

15. The device of claim 14 wherein said passage comprises a weep hole that opens to a volume between said housing wall and said shrink sleeve.

16. The device of claim 13 wherein said wall comprises a first portion and a second portion, and said passage comprises a crimped connection between said wall first portion and said wall second portion.

17. The device of claim 16 wherein said crimp is formed about a crimp flange, said crimp flange comprising a surface that allows pressure to vent past said crimp into a volume between said shrink sleeve and said exterior surface of said housing.

19. The device of claim 18 wherein said surface comprises knurling.

20. The device of claim 16 wherein said crimp retains a heat shrinkable sleeve in an installed position on said housing.

21. The actuator of claim 1 wherein said shrink sleeve comprises a material that shrinks in response to exposure from one or more of the following: heat, chemical, radiation.

22. The actuator of claim 1 wherein said shrink sleeve comprises an elastic material.

23. The device of claim 11 wherein said shrink sleeve comprises a material that shrinks in response to exposure from one or more of the following: heat, chemical, radiation.

24. The actuator of claim 11 wherein said shrink sleeve comprises an elastic material.

25. The device of claim 11 wherein said shrink sleeve includes one or more indicia or other information relating to said flow control device, said actuator or both.

26. The actuator of claim 1 wherein said shrink sleeve includes one or more indicia or other information relating to said actuator.
